(19) United States
(12) Patent Application Publication
(10) Pub. No.: US 2021/0401014 A1
(43) Pub. Date: Dec. 30, 2021

(54) METHOD FOR PICKLING MARINE PRODUCT

(71) Applicant: NIPPON SUISAN KAISHA, LTD., Tokyo (JP)

(72) Inventors: Takashi MORI, Hachioji-shi (JP); Kota INOHARA, Hachioji-shi (JP); Akiko TAKAHASHI, Hachioji-shi (JP); Kiminori SUGIYAMA, Hachioji-shi (JP)

(73) Assignee: NIPPON SUISAN KAISHA, LTD., Tokyo (JP)

(21) Appl. No.: 17/473,520

(22) Filed: Sep. 13, 2021

Related U.S. Application Data
(63) Continuation of application No. PCT/IB2020/000068, filed on Feb. 3, 2020.

(30) Foreign Application Priority Data
Mar. 12, 2019 (JP) 2019-044871
Aug. 5, 2019 (JP) 2019-143712

(51) Int. Cl. A23L 27/40; A23L 17/40; A23L 17/50

(52) U.S. Cl. CPC A23L 27/40; A23L 17/50; A23L 17/40

(57) ABSTRACT

A method for pickling a marine product under conditions satisfying the following a) to c): a) the total ionic strength during treatment is from 0.2 to 0.8 mol/kg; b) the total sodium chloride concentration is less than 1.5% by weight; and c) the pH of the pickled shrimp meat is from 6.5 to 8.6, where, the total ionic strength and total sodium chloride concentration mean the ionic strength and the sodium chloride concentration with respect to the sum of the weight of the marine products and the weight of the water of the pickling solution, assuming that the weight of the marine products is the weight of water.

### CROSS-REFERENCE TO RELATED APPLICATIONS

The present application is a continuation of International Application No. PCT/IB2020/000068, filed Feb. 3, 2020, which is based upon and claims the benefits of priority to Japanese Application No. 2019-044871, filed Mar. 12, 2019 and Japanese Application No. 2019-143712, filed Aug. 5, 2019. The entire contents of all of the above applications are incorporated herein by reference.

### TECHNICAL FIELD

The present invention relates to a method for pickling a marine product. Specifically, it relates to a pickling method capable of suppressing the occurrence of drip due to freezing or heating, and maintaining the original taste and texture of a marine product.

### BACKGROUND ART

Many marine products are distributed frozen to maintain freshness. Raw marine products are foods having a unique texture with a fibrous texture and elasticity. However, freezing and thawing treatment and heat treatment tend to cause drip, resulting in a dry texture. As a result, the yield also decreases. In order to solve this problem, techniques for pickling marine products have been devised for a long time.

The main methods for retaining moisture are a method of adding sodium chloride and a method using an alkali. However, sodium chloride makes water extremely salty and thus its amount of use is restricted. Therefore, marine products have been pickled mainly in an alkaline pickling solution. In a case where shrimp is pickled, alkali has the effect of coloring shrimp red, so it was also preferred from the viewpoint of appearance.

However, the disadvantage of pickling with alkali causes unnatural transparency in the marine product and makes it strange because the meat characteristic that would become opaque when heated remains transparent. In addition, the texture tends to be a jelly-like texture rather than a fibrous texture.

Patent Document 1 describes “a method for producing shrimp with improved texture, taste and surface color, including a step (A) of bringing raw shrimp or thawed shrimp into contact with a surface color improving solution for shrimps for 30 minutes to 24 hours, the surface improving solution for shrimps containing potassium carbonate, calcium oxide, tripotassium citrate, trisodium citrate, salt, sodium glutamate, and water, the content of sodium glutamate in the surface color improving solution for shrimps being from 0.01 to 2.0% by mass, and the pH is from 11.0 to 13.0”.

Patent Document 2 describes “a treating agent for marine products satisfying the following requirements:

(1) it contains sodium gluconate and/or potassium gluconate;

(2) it further contains one or more selected from sodium chloride, trisodium citrate, sodium bicarbonate, sodium carbonate, trisodium phosphate, sodium glutamate, potassium carbonate, tripotassium citrate, and tripotassium phosphate;

(3) the mixing ratio of sodium:potassium is from 1:0 to 1:1.4 in terms of ion weight ratio; and

(4) The pH of the 1% aqueous solution of the treating agent for marine products is in the range of 9.0 or higher but less than 10.5″.

Patent Document 3 describes “a method for producing shrimp with improved texture and transparency, including a step (A) of bringing raw shrimp or thawed shrimp into contact with an alkaline solution with a pH from 10.25 to 10.96, the alkaline solution containing at least one selected from the group consisting of sodium carbonate, sodium bicarbonate, and potassium carbonate, trisodium citrate, one or more divalent alkaline earth metal salts selected from the group consisting of calcium lactate, calcium chloride, and magnesium chloride, and water, and the contact time with the alkaline solution being from 10 to 24 hours”.

In the examples of these prior art documents, the pH and/or sodium chloride concentration is high in all the methods, so that the influence on the taste and texture of marine products cannot be avoided.

### CITATION LIST

### Patent Literature

Patent Document 1: JP 3590615 B

Patent Document 2: JP 3798391 B

Patent Document 3: JP 4109819 B

### SUMMARY OF THE INVENTION

### Technical Problem

An aspect of the present invention is to provide a pickling method that has little influence on the original taste and texture of a marine product, and suppresses drip during freezing and heating.

### Solution to Problem

For pickling of marine products, pickling solutions with a variety of formulations and pickling methods have been devised. However, there is no established effective method for suppressing drip during freezing and heating while maintaining the taste and texture characteristic of raw marine products, more specifically, suppressing the loss of umami and maintaining the texture. Therefore, in the present application, the pickling solution was reviewed in terms of what is essential in order to suppress the drip and hold the yield without affecting the taste and texture.

As a result, it was found that what is important is not the salt type or concentration, but the ionic strength. The finding that the ionic strength is important has led to the finding of a method that maintains the yield with little effect on the taste and texture, in which the amounts of components that affect the taste and texture are reduced and the amounts of components that increase the ionic strength are increased.

An aspect of the present invention is the method for pickling a marine product according to (1) to (20).

(1) A method for pickling a marine product under conditions satisfying the following a) to c):

a) a total ionic strength during treatment is from 0.2 to 0.8 mol/kg;

b) a total sodium chloride concentration is less than 1.5% by weight; and

c) a pH of the pickled marine product is from 0.5 to 8.6, where the total ionic strength and the total sodium chloride concentration mean an ionic strength and a sodium chloride concentration with respect to a sum of a weight of the marine product and a weight of water of a pickling solution, assuming that the weight of the marine product is the weight of the water.

(2) The method according to (1), in which

d) a total trisodium citrate concentration is 1% by w eight or greater.

(3) The method according to (1) or (2), in which the pH of the pickled marine product of c) is from 6.5 to 8.3.

(4) The method according to any one of (1) to (3), in which the salt used for pickling is an organic acid salt and/or an inorganic acid salt that can be used for food.

(5) The method according to (4), in which a salt used for pickling is any one of a sodium salt, a potassium salt, a calcium salt, a magnesium salt, or a combination thereof.

(6) The method according to (4) or (5), in which the salt used for pickling is any one of a citrate, a carbonate, a bicarbonate, ascorbic acid, an erythorbate, a lactate, a succinate, an acetate, a malate, a fumarate, a gluconate, a polymerized phosphate, a hydrochloride, or a combination thereof.

(7) The method according to any one of (1) to (6), in which a pickling time is from 1 to 48 hours.

(8) The method according to any one of (1) to (7), in which the marine product is sprinkled with the salt in powder form, and water is added so as to satisfy conditions a) to c) or a) to d), and then the marine product is pickled therein.

(9) The method according to (8), in which the sprinkling with the salt in powder form is followed by retention for 0.5 to 2 hours, addition of water, and pickling for a total of 1 to 48 hours.

(10) A pickled marine product satisfying the following a) to c):

a) an ionic strength is from 0.2 to 0.8 mol/kg;

b) a sodium chlorideconcentration is less than 1.5% by weight; and

c) a pH is from 6.5 to 8.6.

(11) The marine product according to (10), further satisfying the following d):

d) a trisodium citrate concentration is 1% by weight or greater.

(12) The pickled marine product according to (10) or (11), in which the pH of c) is from 6.5 to 8.3.

(13) The marine product according to any one of (10) to (12), which is pickled with an organic acid salt and/or an inorganic acid salt that can be used for food.

(14) The marine product according to (13), in which the organic acid salt and/or inorganic acid salt is any one of a sodium salt, a potassium salt, a calcium salt, a magnesium salt, or a combination thereof.

(15) The marine product according to (13) or (14), in which the organic acid salt and/or inorganic acid salt is any one of a citrate, a carbonate, a bicarbonate, an ascorbic acid, an erythorbate, lactate, a succinate, an acetate, a malate, a fumarate, a gluconate, a polymerized phosphate, a hydrochloride, or a combination thereof.

(16) A pickling solution with a marine product pickled therein, satisfying the following a) to c):

a) a total ionic strength is from 0.2 to 0.8 mol/kg;

b) a total sodium chloride concentration is less than 1.5% by weight; and

c) a pH is from 7.0 to 9.5.

(17) The pickling solution with a marine product pickled therein according to (16), further satisfying the following d):

d) a total trisodium citrate concentration is 1% by weight or greater.

(18) The pickling solution with a marine product pickled therein according to (16) or (17), in which the salt used is an organic acid salt and/or an inorganic acid salt that can be used for food.

(19) The pickling solution with a marine product pickled therein according to (18), wherein the organic acid salt and/or inorganic acid salt is any one of a sodium salt, a potassium salt, a calcium salt, a magnesium salt, or a combination thereof.

(20) The pickling solution with a marine product pickled therein according to (18) or (19), wherein the organic acid salt and/or an inorganic acid salt is any one of a citrate, a carbonate, a bicarbonate, ascorbic acid, an erythorbate, a lactate, a succinate, an acetate, a malate, a fumarate, a gluconate, a polymerized phosphate, a hydrochloride, or a combination thereof.

### Advantageous Effects

The use of the pickling method according to an aspect of the present invention suppresses the drip during freezing and heating, suppresses the loss of umami, and maintains the yield, while preventing the influences on the taste, appearance and texture of marine products, specifically salty taste caused by salts, transparency caused by alkali, and jelly-like texture caused by alkali.

### BRIEF DESCRIPTION OF DRAWINGS

FIG. 1 is a graph showing the pickling yield of shrimp pickled in a pickling solution using various salts of Example 1, with the concentration (% by weight) of the salts in the pickling solution as the horizontal axis.

FIG. 2 is a graph showing the pickling yield of shrimp pickled in a pickling solution using the various salts of Example 1, with the total ionic strength (mol/kg) as the horizontal axis.

FIG. 3 is a graph showing the pickling yield of shrimp pickled by the sprinkling method of Example 5, with the total ionic strength as the horizontal axis.

FIG. 4 is a diagram showing the results (taste and flavor) of the sensory evaluation of Example 6. In the figure, ** indicates a significant difference with a probability of a risk rate of 1% or less, * indicates a significant difference with a probability of a risk rate of 5% or less, and † indicates a significant difference with a probability of a risk rate of 10% or less.

FIG. 5 is a diagram showing the results (texture) of the sensory evaluation of Example 6. In the figure, ** indicates a significant difference with a probability of a risk rate of 1% or less, and * indicates a significant difference with a probability of a risk rate of 5% or less.

FIG. 6 is a diagram showing the results (appearance) of the sensory evaluation of Example 6. In the figure, ** indicates a significant difference with a probability of a risk rate of 1% or less, and * indicates a significant difference with a probability of a risk rate of 5% or less.

FIG. 7 is a photograph showing the appearance of heated shrimp in Comparative Example 1, Formulation 2, and Comparative Example 2 of Example 6.

FIG. 8 is a micrograph (40 magnification) of muscle fibers of shrimp of Example 6 in a cross section.

FIG. 9 is a graph plotting the pH of the pickling solution and the pH of the pickled shrimp meal in Example 7.

### DESCRIPTION OF EMBODIMENTS

An aspect of the present invention relates to a method for pickling a marine product.

The marine products which are targeted in the present application are not particularly limited as long as they are edible ones among fish, crustaceans, and mollusks. Specifically, examples of crustaceans include shrimps, and examples of mollusks include squids, octopuses, and adductors of shellfish.

The shrimps that are targeted in the present application are those used for food among organisms belonging to Arthropoda, Crustacean, Malacostraca, Decapoda (Order Decapoda). Specific examples include Alpheus brevicristatus, Marsupenaeus japonicus, Penaeus monodon (black tiger prown), Litopenaeus vannamei, Metapenaeus joyneri, Trachysalambria curvirostris, Ibacuc ciliatus, Acropora shrimps, Stenopus hispidus, Panulirus japonicus, Scyllarides squamosus, lobster, Lucensosergia lucens, Pasiphaea japonica, Pandalus eous (sweet shrimp), Metanephrops japonicus, Palaemon pacificus, Pandalus latirostris, Heptacarpus geniculatus, Heptacarpus rectirostris, freshwater prawns, Palaemon paucidens, Paratya compressa, clayfish, and red swamp crayfish.

The shrimp may be raw or frozen and thawed.

The squids which are targeted in the present application are those used for food among organisms belonging to Mollusk, Cephalopod, Colcoidea, Decapodiformes. Specific examples include Todarodes pacificus, Heterololigo bleekeri, Uroteuthis edulis (Decapodiformes), Ommastrephes bartramii (purple squid), Sepioteuthis lessoniana, Thysanoteuthis rhombus, cuttlefish, Ocellated cuttlefish, Sepiella japon, Euprymna morsei, reef cuttlefish, dwarf squid, Watasenia scintillans, and Dosidicus gigas. The squid may be raw or frozen and thawed.

The octopuses which are targeted in the present application are those used for food among organisms belonging to Mollusea, Cephalopod, Colcoidea, Octopodiformes (Octopus eyes). Specific examples include Octopus sinensis, Octopus dofleini, Octopus ocellatus, Octopus membranaceus, Octopus cyanea Gray, Octopus conispadiceus, Octopus minor, and Benthoctopus profundorum Robson. The octopus may be raw or frozen and thawed.

The adductor of the shellfish which is targeted in the present application is those used for food among adductors of organisms belonging to Mollusk, Bivalves, Pectinoida or Order Mytiloida. Specifically, examples of organisms belonging to Pectinoida include scallop, noble scallop, and Japanese bay scallop, and examples of organisms belonging to Order Mytiloida include Atrina pectinata and blue mussel. The adductor of shellfish may be raw or frozen and thawed.

As represented by the following equation, the ionic strength is obtained by adding the product of the molar concentration of each ion and the square of the charge for alt ionic species in the solution, and halving it.

$$I = \frac{1}{2} {\sum }_{i} {m}_{i} {z}_{i}^{2} \qquad [ Equation 1 ]$$

The ionic strength of the aqueous solution of the pickling solution can be calculated according to this equation. However, even if the aqueous solution ionic strength of the pickling solution is determined, the effect will also change if the amount of the pickling solution relative to the marine product changes.

In the present application, the “total ionic strength”, “total sodium chloride concentration”, and “total trisodium citrate concentration” are not the ionic strength or salt concentration of the pickling solution, but the ionic strength, sodium chloride concentration, and trisodium citrate concentration in the sum of the weight of the marine product and the weight of water in the pickling solution, assuming that the weight of the marine product is also the weight of water.

The present inventors found that the ionic strength at the stage where the salt penetrated into the marine product pickled in the pickling solution and became constant was important. The weight of the marine product is regarded as the amount of water, and the “(aqueous solution ionic strength×amount of aqueous solution)/(amount of aqueous solution+weight of shrimp)” is defined as the total ionic strength.

Similarly, regarding the concentration of salts such as sodium chloride, the “(concentration in aqueous solution×amount of aqueous solution)/(amount of aqueous solution+weight of marine product)” as the total concentration.

Such definition of the total ion concentration and the total concentration allows production of marine products pickled as designed, without difference in effect depending on the amount of the pickling solution and the amount of the marine products.

In a case where shelled shrimp is used, the penetration of the pickling solution becomes slightly worse due to the presence of the shell. However, the shell is lightweight and has no significant effect, so the weight of shrimp can be calculated as the weight of water for both peeled shrimp and shelled shrimp.

The formulation for pickling according to an aspect of the present invention satisfies the following conditions a) to c):

a) the total ionic strength during treatment is from 0.2 to 0.8 mol/kg;

b) the total sodium chloride concentration is less than 1.5% by weight, and

c) the pH of the pickled marine product is from 6.5 to 8.6.

The pickled marine product that satisfies the following conditions a) to c) means marine products pickled by the pickling method that satisfies the above conditions a) to c):

a) the ionic strength is from 0.2 to 0.8 mol/kg:

b) the sodium chloride concentration is less than 1.5% by weight, and

c) the pH is from 6.5 to 8.6.

Similarly, the pickled marine product satisfying the condition of d) trisodium citrate concentration of 1% by weight or greater means a marine product pickled by the pickling method that satisfies the following condition d):

d) the total trisodium citrate concentration is 1% by weight or greater.

The total ionic strength during pickling is from 0.2 to 0.8 mol/kg, preferably from 0.3 to 0.7 mol/kg, and more preferably from 0.4 to 0.7 mol/kg. The total sodium chloride concentration is less than 1.5% by weight, preferably 1.2% by weight or less, more preferably 1.0% by weight or less, 0.8% by weight or less, and 0.75% by weight or less. There is no lower limit to the sodium chloride concentration, and it may be zero, but the total concentration is preferably at least 0.01% by weight, 0.02% by weight, 0.03% by weight, 0.05% by weight or more, because the salty taste also has the effect of enhancing the umami of the marine product. This is not the case when the salty taste may be strong due to other seasonings. The marine product is pickled so that the pH of the pickled marine product is from 6.5 to 8.6. Preferably, it is pickled to have a pH of from 6.6 to 8.3. more preferably from 7.0 to 8.2, from 7.0 to 8.1, and from 7.0 to 8.0. Since the pH of the pickled marine product is highly correlated with the pickling solution, the pH of the marine product can be easily adjusted by adjusting the pH of the pickling solution. The pH of the pickling solution is from 7.0 to 9.5, preferably from 7.0 to 9.3, from 7.0 to 9.0, more preferably 7.0 or higher but less than 9.0, from 7.0 to 8.8, and from 7.0 to 8.5. The pH of the pickled marine product is the pH of the liquid after the pickled marine product is minced, 10 times the amount of water is added, and the mixture is stirred thoroughly.

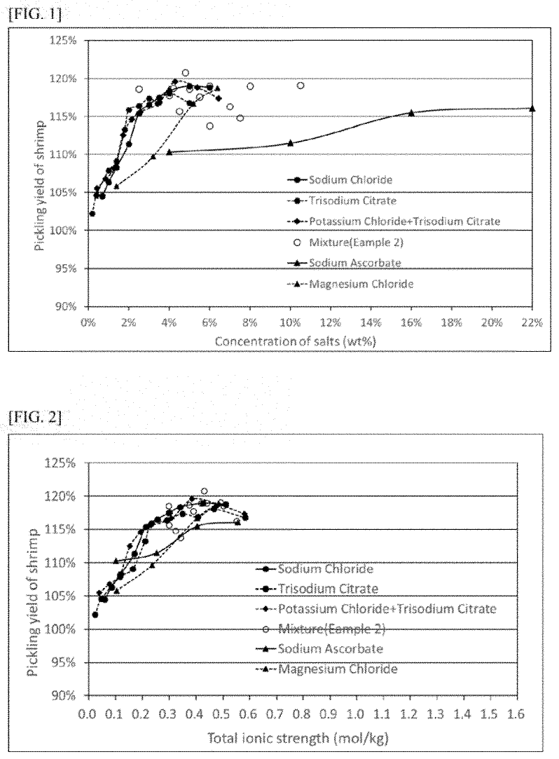

By setting the total ionic strength in the range from 0.2 to 0.8 mol/kg, the water retaining capacity of the marine product is increased, the yield is increased, and thus the drip can be decreased. In related art, the concentration of sodium chloride and alkali salt in the pickling solution was defined in % by weight, molar concentration, and the like of aqueous solution. However, as shown in Example 1 (FIG. 1 and FIG. 2), it was found that the effect of decreasing drip strongly correlates with the ionic strength. By calculating the ionic strength even w hen the molecular weight, properties, and the like of the salt change, mixing of multiple salts is facilitated, and the formulation of the desired pickling solution can be determined.

Furthermore, by adopting the total ionic strength including the weight of the marine product, instead of the ionic strength of the aqueous solution, the design can be made in consideration of the influence of the change in the ratio of the amount of the pickling solution to the amount of the marine product.

In addition, the finding of the importance of the total ionic strength has revealed what ingredients should be selected to reduce the influence on the too strong salty taste caused by sodium chloride and the texture caused by alkalis. Since the ionic strength is obtained by multiplying the molar concentration by the square of the charge, the lower the molecular weight of the salt is and the higher the charge is, the greater the ionic strength becomes even at the same concentration.

For example, when sodium chloride having a monovalent sodium ion and a chloride ion is compared with trisodium citrate having three monovalent sodium ions and a trivalent citrate ion, there is a 6-fold difference in the ionic strength even at the same molar concentration. When the molecular weight is taken into account, the molecular weight of sodium chloride is 58.44 g/mol, and the molecular weight of trisodium citrate is 258.06 g/mol, which is the difference of about 4.4 times. Therefore, in a case where sodium chloride and trisodium citrate are used at the same ionic strength, sodium chloride must be used 1.4 times in terms of concentration in % by weight.

In order to increase the ionic strength at a low concentration, salts containing ions with low molecular weight and high charge are preferable. Among the salts used in food, trisodium citrate and the like are found to be suitable. As indicated in Example 3, by adjusting the ionic strength by using trisodium citrate so that the total concentration is at least 1% by weight or greater, preparation at the ionic strength within a range that does not affect the salty taste is possible.

In addition to sodium chloride and trisodium citrate, specific examples of organic acid salts and/or inorganic acid salts that can be used in food include any one of sodium salts, potassium salts, calcium salts, magnesium salts, combinations thereof, and citrates, carbonates, bicarbonatcs, ascorbic acid, erythorbates, lactates, succinates, acetates, malates, fumarates, gluconates, polymerized phosphates, hydrochlorides, and combinations thereof.

Specific examples include sodium chloride, trisodium citrate, potassium chloride, tripotassium citrate, calcium citrate, sodium lactate, sodium succinate, sodium acetate, sodium malate, sodium fumarate, sodium gluconate, potassium gluconate, calcium gluconate, calcium lactate, magnesium chloride, calcium chloride, sodium erythorbate, and polymerized phosphates.

Examples of the preferable pickling method include the following embodiments.

An embodiment in which the total ionic strength is adjusted to from 0.2 to 0.8 mol/kg by adding from 1 to 4% by weight of trisodium citrate and no sodium chloride or 1% by weight or less of salt as a total concentration, or an embodiment in which the total ionic strength is adjusted to from 0.2 to 0.8 mol/kg by further adding, as other salt(s), one or more salts selected from potassium chloride, tripotassium citrate, calcium citrate, sodium lactate, sodium succinate, sodium acetate, sodium malate, sodium fumarate, sodium gluconate, potassium gluconate, calcium gluconate, calcium lactate, magnesium chloride, calcium chloride, sodium erythorbate, polymerized sodium phosphate, and the like.

The pickling is carried out at a temperature that does not affect the quality of the marine product, usually from 0 to 20° C. for 1 to 48 hours, preferably from 3 to 36 hours for 4 to 24 hours, more preferably from 5 to 24 hours, and from 5 to 18 hours. Depending on the size of the marine product, it can be pickled fairly uniformly in one hour. Three hours are sufficient. There is no upper limit for the pickling time, but it is not necessary to unnecessarily increase the pickling lime so as not to affect the quality of the marine product, and an appropriate lime is set in relation to other work. It is preferable to pickle the marine product until the pickling solution penetrates to the center of the marine product to a uniform concentration, thereby eliminating unevenness in taste and texture.

The pickling may be performed by a method for pickling a marine product in a pickling solution in which the formulation for pickling is dissolved, a method of sprinkling a marine product with powder in the formulation for pickling, and then adding water for pickling the marine product, or a method of sprinkling powder alone without adding water.

In a case where powder is sprinkled, the marine product is sprinkled with the salt in powder form, water is added, and the marine product is pickled under conditions that satisfy a) to c). Specifically, after sprinkling with the salt in powder form, the marine product is kept for 0.5 to 2 hours, water is added, and the marine product is pickled usually at 0 to 20° C. for a total of from 1 to 48 hours, preferably from 3 to 36 hours, from 4 to 24 hours, more preferably from 5 to 24 hours, and from 5 to 18 hours. The sprinkling with powder can greatly reduce the amount of water and the salt used, and can also prevent umami from flowing into the pickling solution. In a case where powder is sprinkled, the marine product is sprinkled with the salt in powder form, and water is added so as to satisfy the conditions a) to c), and further satisfy the condition d). The effect of pickling after adding water can be considered in the same manner as in the pickling solution.

In a case where powder alone is sprinkled, the marine product is pickled only with the moisture contained in the marine product. Since the yield is better in a case where water is added, it is preferable to add water, but powder alone is also possible.

The marine product pickled by the method according to an aspect of the invention has a good texture and is preferable for eating.

The present invention will now be described in greater detail through examples, but is in no way limited thereto.

### Example 1

### Ionic Strength of Pickling Agent

In order to maintain the yield of shrimp, pickling with sodium chloride or an alkali agent is performed in various combinations of different components. In order to find out which component is most important and how to use it, pickling with various components was performed.

Sodium chloride, trisodium citrate, potassium chloride+trisodium citrate, sodium ascorbate, magnesium chloride were used as the pickling components, and pickling solutions having different concentrations thereof were prepared. Frozen whiteleg shrimp (peeled shrimp) was thawed and pickled for 18 hours using a 100% by weight pickling solution with respect to the weight of the shrimp.

The results are shown in FIG. 1. The results commonly showed that the yield increased as the salt concentration in the pickling solution increased. However, regarding which components should be used in what ratio when these are used in combination, no index was obtained.

FIG. 1 is plotted using the concentration of salts in % by weight in the pickling solution as the horizontal axis, while FIG. 2 is a graph using the ionic strength as the horizontal axis. The horizontal axis in FIG. 2 represents the total ionic strength.

“Total ionic strength” means the ionic strength in the total amount of the pickling solution and the weight of shrimp. When the ionic strength of the pickling solution is “aqueous solution ionic strength”, it is represented by “(aqueous solution ionic strength x aqueous solution amount)/(aqueous solution amount+shrimp amount)”. Therefore, when the pickling solution has a weight ratio of 100% to shrimp, the total ionic strength is ½ of the ionic strength of the aqueous solution.

As shown in FIG. 2, when considering the yield with an index of total ionic strength, an approximate curve is plotted regardless of the type of salt. Therefore, the use of the index of the total ionic strength allows design of the pickling solution independent of the type of salt, and further allows the design that takes into account the amounts of the pickling solution and shrimp.

### Example 2

The pickling solutions were prepared with the 12 formulations shown in Table 1-1 and Table 1-2. Frozen whiteleg shrimp (peeled shrimp) was thawed and pickled for 18 hours in a 100% by weight pickling solution with respect to the weight of shrimp. Comparative Example 1 was not pickled, and Comparative Example 2 used a pickling solution with a high pH. The heat treatment after pickling was boiled with hot water at 100° C. for 90 seconds, followed by cooling with ice water for 1 minute.

The definitions of “aqueous solution ionic strength” and “total tonic strength” in Table 1-1 and Table 1-2 are the same as in Example 1.

The pickling yield, which is the ratio of the weight after pickling to the weight before pickling, and the heating yield, which is the ratio of the weight after heating to the weight before heating, were measured, and sensory evaluation of shrimp texture was performed using the sample after heating. The texture of the shrimp was evaluated as follows in increments of 0.5 (n=3) based on an evaluation standard of 0 to 2 points: “texture having a feel of shrimp fibers (2 points)”, “slightly jelly-like texture (1 point)”, and “overall jelly-like texture (0 point). A score of 1 or lower was judged to be unpleasant because the texture was not shrimp-like.

The results were plotted as mixtures (white circles) in FIG. 1 and FIG. 2. Even for a pickling solution prepared by mixing various salts, it was confirmed that a value approximate to that obtained when various salts are used alone is obtained by plotting the total ionic strength. From these results, it was confirmed that in designing the pickling solution, it is appropriate to make a judgment based on the total ionic strength of each salt.

From the results of FIG. 2, it was found that the total ionic strength needs to be set to at least 0.2 mol/kg or greater, preferably 0.3 mol kg or greater. In particular, it was found that a stable yield could be obtained with any salt when the concentration was set to 0.4 mol/kg or greater.

In addition, it was found that the shrimp-like texture was impaired when the pH of the pickling solution exceeded 10, even if the ionic strength was appropriate.

TABLE 1-1

| | | Formu- | Formu- | Formu- | Formu- | Formu- | Formu- | Formu- | Compar- | Compar- |
|---|---|---|---|---|---|---|---|---|---|---|
| | | lation | lation | lation | lation | lation | lation | lation | ative | ative |
| | | 1 | 2 | 3 | 4 | 5 | 6 | 7 | Example 1 | Example 2 |
| Formu- | Sodium Chloride | 1.0 | 1.0 | 0.5 | 1.0 | 1.0 | 1.0 | | not | 1.5 |
| lation | Trisodium Citrate | 2.0 | 3.0 | 1.0 | | 0.0 | 2.0 | | pickled | |
| (wt %) | Potassium Chloride | 1.0 | 1.0 | | 3.0 | 2.0 | 2.0 | 3.0 | | |
| | Sodium Ascorbate | 1.0 | | 3.0 | 1.0 | 2.0 | 1.0 | 1.0 | | |
| | Monosodium | 1.0 | | 3.0 | 1.0 | 2.0 | 1.0 | 1.0 | | |
| | Glutamate | | | | | | | | | |
| | Sodium hydrogen | | | | | 1.0 | | 0.5 | | |
| | Carbonate | | | | | | | | | |
| | Sodium Carbonate | | | | | | | | | 1.0 |
| | Sucrose | | | | | | 5.0 | | | |

| | | | | | | | | | |
|---|---|---|---|---|---|---|---|---|---|
| Aqueous solution ionic | 0.88 | 1.00 | 0.65 | 0.68 | 0.84 | 1.10 | 0.60 | | 0.60 |
| strength (mol/Kg) | | | | | | | | | |
| Total ionic strength (mol/Kg) | 0.44 | 0.50 | 0.32 | 0.34 | 0.42 | 0.55 | 0.30 | | 0.30 |
| pH of aqueous solution | 7.65 | 7.99 | | | | 7.51 | | | 10.12 |
| The pickling yield (wt %) | 119.0 | 118.6 | 114.8 | 113.8 | 119.0 | 116.3 | 117.6 | | 118.6 |
| The heating yield (wt %) | 88.8 | 90.1 | 86.7 | 89.6 | 88.7 | 89.8 | 87.7 | 72.0 | 90.4 |
| The texture of the shrimp | 2 | 2 | 2 | 2 | 2 | 2 | 2 | 2 | 0 |

TABLE 1-2

| | | Formulation | Formulation | Formulation | Formulation | Formulation |
|---|---|---|---|---|---|---|
| | | 8 | 9 | 10 | 11 | 12 |
| Formulation | Sodium Chloride | 1.5 | 0.5 | 1.0 | 0.5 | 0.5 |
| (wt %) | Trisodium Citrate | 1.0 | 1.5 | 1.0 | 1.0 | 2.0 |
| | Potassium Chloride | | 0.5 | 1.0 | | 2.3 |
| | Sodium Ascorbate | 5.0 | | | 1.0 | |
| | Monosodium Glutamate | | | | | |
| | Magnesium Chloride | 1.0 | | 0.2 | | |
| | Tripotassium Citrate | | 1.5 | 1.0 | 1.0 | |
| | Sodium Gluconate | 2.0 | | | 1.0 | |

| | | | | | |
|---|---|---|---|---|---|
| Aqueous solution ionic strength | 0.98 | 0.78 | 0.75 | 0.6 | 0.86 |
| Total ionic strength (mol/Kg) | 0.49 | 0.39 | 0.38 | 0.30 | 0.43 |
| The pickling yield (wt %) | 119.1 | 117.8 | 118.7 | 115.7 | 120.8 |
| The heating yield (wt %) | 87.7 | 88.0 | 90.0 | 89.5 | 90.5 |
| The texture of the shrimp | 2 | 2 | 2 | 2 | 2 |

### Example 3

### Influence of Total Ionic Strength and pH of Aqueous Solution on Yield

In order to examine the pH that affects shrimp-like texture, pickling solutions were prepared with the six formulations shown in Table 2. Frozen whiteleg shrimp (peeled shrimp) was thawed and pickled for 18 hours using a 100% by weight pickling solution with respect to the weight of the shrimp.

The definition of the measurement items in Table 1 is the same as in Example 1, and the sensory evaluation was performed on the heated sample in the same manner as in Example 2.

The results are shown in Table 2. It was confirmed that the shrimp-like texture was impaired when the pH of various pickling solutions was 9.5 or higher.

TABLE 2

| | | Formulation | Formulation | Formulation | Formulation | Formulation | Formulation |
|---|---|---|---|---|---|---|---|
| | | 1 | 2 | 3 | 4 | 5 | 6 |
| Formulation | Sodium Chloride | 1.5 | 1.5 | 1.5 | 1.5 | 1.5 | 1.5 |
| (wt %) | Trisodium Citrate | 2.0 | 2.0 | 2.0 | 2.0 | 2.0 | 2.0 |
| | Potassium Chloride | 1.0 | 1.0 | 1.0 | 1.0 | 1.0 | 1.0 |
| | Sodium Ascorbate | 1.0 | 1.0 | 1.0 | 1.0 | 1.0 | 1.0 |
| | Sodium Carbonate | | 0.1 | 0.3 | 0.5 | 0.6 | 0.8 |
| | Sodium hydrogen Carbonate | 1.0 | | | | | |

| | | | | | | |
|---|---|---|---|---|---|---|
| pH of aqueous solution | 8.63 | 8.80 | 9.27 | 9.55 | 9.93 | 10.44 |
| Aqueous solution ionic strength (mol/Kg) | 1.08 | 0.93 | 0.99 | 1.05 | 1.08 | 1.13 |
| Total ionic strength (mol/Kg) | 0.54 | 0.47 | 0.50 | 0.52 | 0.54 | 0.57 |
| The pickling yield (wt %) | 115.6 | 113.2 | 116.5 | 116.8 | 118.2 | 119.4 |
| The texture of the shrimp | 2 | 2 | 1.5 | 1 | 1 | 0 |

### Example 4

### Salty Taste When Using Trisodium Citrate in Place of Sodium Chloride

The increase of the ionic strength of the pickling solution naturally requires the increase of the concentration of salts.

The pickling solutions were prepared with the 7 formulations shown in Table 3. Frozen whiteleg shrimp (peeled shrimp) was thawed and pickled for 18 hours using a 100% by weight pickling solution with respect to the weight of the shrimp.

The definition of the measurement items in Table 3 is the same as in Example 1, and the sensory evaluation was performed on the heated sample in the same manner as in Example 2. In the present example, sensory evaluation of salty taste was also performed. The texture of the shrimp was evaluated in the same manner as in Example 1, and the salty taste was evaluated as follows in increments of 0.5 (n=3) based on an evaluation standard of 0 to 2 points: “extremely salty: 2.0 points”, “strongly salty: 1.5 points”, “moderately salty: 1.0 point”, “slight salty taste: 0.5 points”, and “no salty taste: 0 points”. A score of 1.5 or higher was judged to be unpleasant because the salty taste was excessively strong.

The results are shown in Table 3. In all cases, the ionic strength and the yield were similar, but there was a significant difference in the salty taste. The ionic strength is obtained by adding the product of the molar concentration of each ion and the square of the charge for all ionic species in the solution, and halving it. Therefore, when sodium chloride having a monovalent sodium ion and a chloride ion is compared with trisodium citrate having three monovalent sodium ions and a trivalent citrate ion, there is a 6-fold difference in the ionic strength at the same molar concentration. Taking the molecular weight into consideration, the molecular weight of sodium chloride is 58.44 g/mol, and the molecular weight of trisodium citrate is 258.06 g/mol, which is the difference of about 4.4 times. Therefore, in a case where sodium chloride and trisodium citrate are used at the same ionic strength, sodium chloride must be used 1.4 times in terms of concentration in % by weight.

In order to increase the ionic strength at a low concentration, salts containing ions having a low molecular weight and high charge are preferable. It can be seen that trisodium citrate is suitable among the salts used for food.

As shown in Table 3, by adjusting the ionic strength using less than 3.0% by weight of sodium chloride concentration (total sodium chloride concentration is less than 1.5% by weight) and 2% by weight or more of trisodium citrate (total concentration of trisodium citrate is 1% by weight or more), the ionic strength can be adjusted to a preferable strength within a range that does not affect the salty taste.

TABLE 3

| | | Formulation | Formulation | Formulation | Formulation | Formulation | Formulation | Formulation |
|---|---|---|---|---|---|---|---|---|
| | | 1 | 2 | 3 | 4 | 5 | 6 | 7 |
| Formulation | Sodium Chloride | 0.0 | 0.5 | 1.0 | 1.5 | 2.0 | 3.0 | 3.5 |
| (wt %) | Trisodium Citrate | 3.5 | 3.1 | 2.8 | 2.4 | 2.0 | 1.3 | 0.9 |

| | | | | | | | |
|---|---|---|---|---|---|---|---|
| Aqueous solution ionic strength (mol/Kg) | 0.81 | 0.81 | 0.82 | 0.81 | 0.81 | 0.82 | 0.81 |
| Total ionic strength (mol/Kg) | 0.41 | 0.40 | 0.41 | 0.41 | 0.40 | 0.41 | 0.40 |
| The pickling yield (wt %) | 115.6 | 113.2 | 116.5 | 116.8 | 118.2 | 119.4 | 118.6 |
| Salty taste | 0.0 | 0.5 | 0.5 | 1.0 | 1.0 | 1.5 | 2.0 |
| The texture of the shrimp | 2 | 2 | 2 | 2 | 2 | 2 | 2 |

### Example 5

Pickling by Sprinkling with Powder

In order to confirm that the total ionic strength including the weight of shrimp is more important than the ionic concentration in the aqueous solution, it was attempted to pickle shrimp with powdered salt instead of an aqueous solution so as to reduce the water amount.

Sodium chloride, potassium chloride+trisodium citrate were used in the form of powder as the pickling components. Frozen whiteleg shrimp was thawed and mixed with different amounts of powder to be sprinkled, and after one hour, 20% by weight of water was added with respect to the weight of shrimp, and the shrimp was pickled for 18 hours.

As for the total ionic strength in the case of sprinkling with powder, the weight of shrimp was treated as the weight of water, and the ionic strength of the added powder was calculated with respect to the sum of the weight of shrimp and the amount of added water.

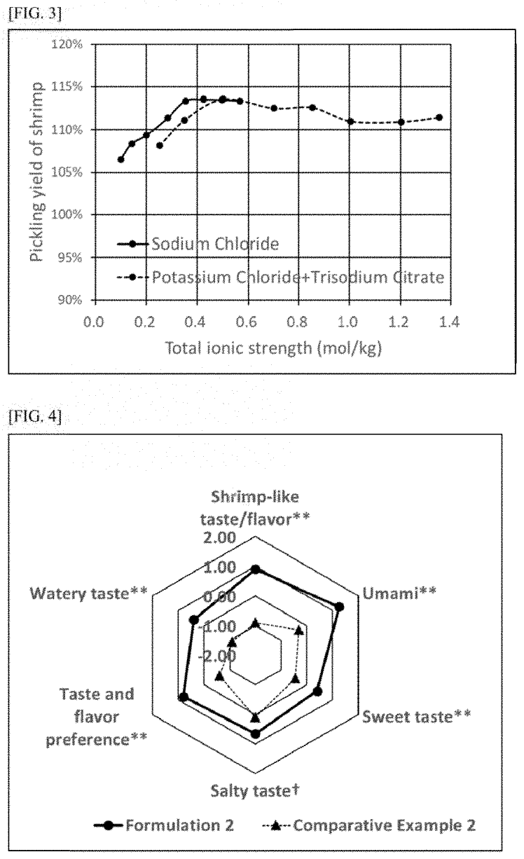

The results are shown in FIG. 3. It was found that even in pickling by sprinkling with powder, which uses a reduced amount of water, a stable yield could be obtained by setting the total ionic strength to at least 0.2 mol/kg or greater, preferably 0.3 mol kg or greater, and particularly preferably 0.4 mol/kg or greater. It was confirmed from this result that it is appropriate to use the total ionic strength including the weight of shrimp, rather than the ionic strength of the aqueous solution.

### Example 6

### Evaluation of Shrimp

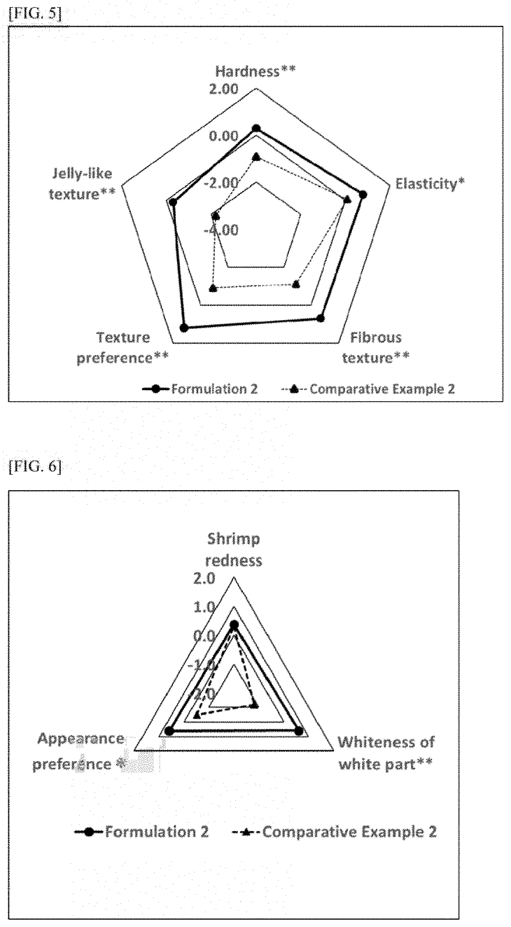

Of the formulations shown in Table 1-1 of Example 2, the pickling solutions of the formulation 2 and Comparative Example 2 were used for pickling, and the shrimp after pickling and heating was subjected to the sensory test. Sensory evaluation was performed on taste/flavor, texture, and appearance by 10 specialist panels. The evaluation items were independent evaluations for the items shown in FIG. 4 to FIG. 6. Each evaluation item was evaluated based on 7-level evaluation criteria: “−3: Very weak, −2: Weak, −1: Slightly weak, 0: Same, +1: Slightly strong, +2: Strong, +3: Very strong”.

The results are shown in FIG. 4 to FIG. 6. The product of the inventive example was judged to be preferable for any item (“Watery taste” and “Jelly-like texture” are plotted in positive and negative directions).

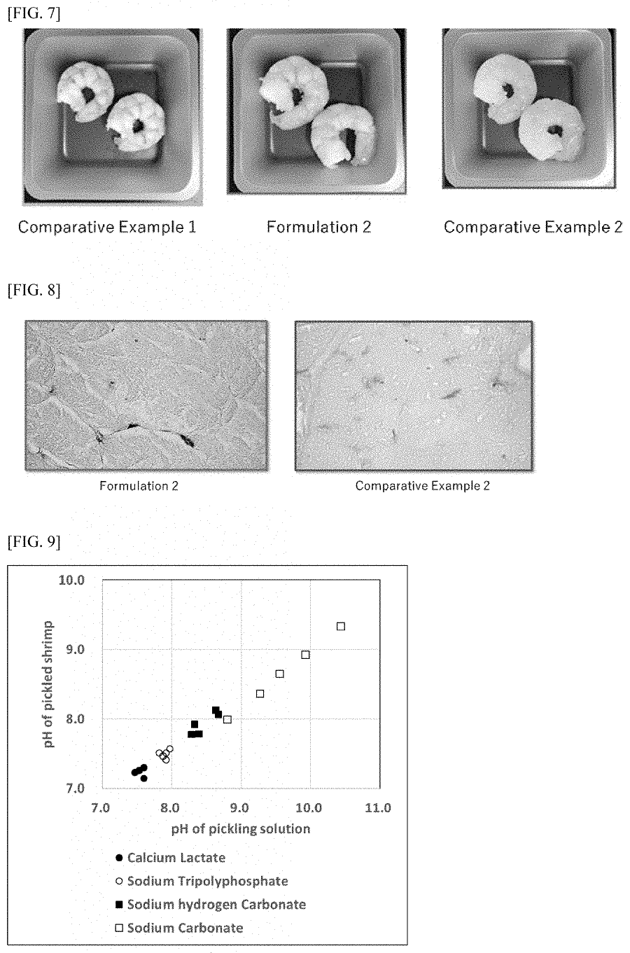

In addition, FIG. 7 shows photographs after heating of the shrimp of Comparative Example 1 and the shrimp pickled in the pickling solutions of Formulation 2 and Comparative Example 2 in Table 1-1. It can be seen that the shrimp pickled in the pickling solution of the inventive example did not shrink in the body like the shrimp that was not pickled (Comparative Example 1), did not have a jelly-like transparency like the shrimp pickled in a prior art alkaline pickling solution (Comparative Example 2), and maintained a favorable appearance.

Furthermore, the muscle fiber tissue sections of the cross-section of the shrimp pickled in the pickling solutions of Formulation 2 and Comparative Example 2 were observed using an optical microscope (40 magnification). Photographs are shown in FIG. 8. It can be seen that the pickling solution of the example has less influence on the muscle fibers compared with the known alkaline pickling solution.

### Example 7

### The pH of the Pickling Solution and the pH of the Pickled Shrimp

In order to confirm the relation between the pH of the pickling solution and the pH of the pickled shrimp meat, the pickling solutions of 20 compositions shown in Table 4 were prepared, and frozen whiteleg shrimp were thawed and pickled for 20 hours using the pickling solutions. In Table 4, the salt concentration is expressed as the total concentration. The weight ratio of the pickling solution to shrimp was 1:1.

The pH of the pickling solution before pickling and the pH of the shrimp meal after pickling were measured. The pH of the shrimp meat was measured as follows: the shrimp abdominal segment muscles were minced, 10 times the amount of water was added, the mixture was stirred thoroughly, and the pH of the liquid was used as the pH of the shrimp meat. The pH of the shrimp meat before pickling was 7.0.

The results are shown in Table 4 and FIG. 9. As shown in FIG. 9, the pH of the pickling solution and the pH of the shrimp meat correlate very well. It was found that the pH of the pickled shrimp meat in a pickling solution with a pH of 7.0 to 9.5 was from 7.0 to 8.6, and the pH of the pickled shrimp meat in a pickling solution with a pH of 7.0 to 9.0 was from 7.0 to 8.3.

TABLE 4

| | The total concentration (wt %) | | | | |
|---|---|---|---|---|---|
| Formulation 1 | | | | | |
| Trisodium Citrate | 1.0 | | | | |
| Sodium Chloride | 0.3 | | | | |
| Potassium Chloride | 1.5 | | | | |
| Calcium Lactate | 0.1 | 0.3 | 0.5 | 0.6 | 0.8 |
| Water + Shrimp | 97.1 | 96.9 | 96.7 | 96.6 | 96.4 |
| Total | 100 | 100 | 100 | 100 | 100 |
| The pH of the | 7.53 | 7.60 | 7.47 | 7.59 | 7.60 |
| pickling solution | | | | | |
| The pH of the | 7.26 | 7.15 | 7.24 | 7.30 | 7.30 |
| pickled shrimp | | | | | |
| Formulation 2 | | | | | |
| Trisodium Citrate | 1.0 | | | | |
| Sodium Chloride | 0.3 | | | | |
| Potassium Chloride | 1.5 | | | | |
| Sodium Tripolyphosphate | 0.1 | 0.3 | 0.5 | 0.6 | 0.8 |
| Water + Shrimp | 97.1 | 96.9 | 96.7 | 96.6 | 96.4 |
| Total | 100.0 | 100.0 | 100.0 | 100.0 | 100.0 |
| The pH of the | 7.97 | 7.87 | 7.92 | 7.81 | 7.92 |
| pickling solution | | | | | |
| The pH of the | 7.57 | 7.47 | 7.42 | 7.51 | 7.52 |
| pickled shrimp | | | | | |
| Formulation 3 | | | | | |
| Trisodium Citrate | 1.0 | | | | |
| Sodium Chloride | 0.3 | | | | |
| Potassium Chloride | 1.5 | | | | |
| Sodium hydrogen Carbonate | 0.1 | 0.2 | 0.3 | 0.4 | 0.5 |
| Water + Shrimp | 97.1 | 97 | 96.9 | 96.8 | 96.7 |
| Total | 100 | 100 | 100 | 100 | 100 |
| The pH of the | 8.28 | 8.39 | 8.33 | 8.67 | 8.63 |
| pickling solution | | | | | |
| The pH of the | 7.78 | 7.79 | 7.93 | 8.07 | 8.13 |
| pickled shrimp | | | | | |
| Formulation 4 | | | | | |
| Trisodium Citrate | 1.0 | | | | |
| Sodium Chloride | 0.3 | | | | |
| Potassium Chloride | 1.5 | | | | |
| Sodium Carbonate | 0.1 | 0.3 | 0.5 | 0.6 | 0.8 |
| Water + Shrimp | 97.1 | 96.9 | 96.7 | 96.6 | 96.4 |
| Total | 100.0 | 100.0 | 100.0 | 100.0 | 100.0 |
| The pH of the | 8.80 | 9.27 | 9.55 | 9.93 | 10.44 |
| pickling solution | | | | | |
| The pH of the | 8.00 | 8.37 | 8.65 | 8.93 | 9.34 |
| pickled shrimp | | | | | |

### Example 8

### Effect of Pickling on Squid

In order to examine the effect of pickling on squid, the pickling solution was prepared according to the formulation shown in Table 5. Frozen squid (Todarodes pacificus) was thawed, cut to from 5 to 10 g, and pickled for 18 hours using a 100% by weight pickling solution with respect to the weight of the squid. The heat treatment after pickling was boiled for 2 minutes in hot water at 100° C., followed by cooling with ice water for 1 minute.

The definition of the measurement items in Table 5 was the same as in Example 1, and the sensory evaluation was performed on the heated sample in the same manner as in Example 2. The texture of the squid was evaluated as follows in increments of 0.5 (n=3) based on an evaluation standard of 0 to 2 points; “texture having a feel of squid elasticity (2 points)”, “slightly jelly-like texture (1 point)”, and “overall jelly-like texture (0 point). A score of 1 or lower was judged to be unpleasant because the texture was not squid-like.

The results are shown in Table 5. Also in squid, it was found that the yield alter pickling was high, and the squid-like texture was maintained by satisfying the conditions of the total ionic strength being from 0.2 to 0.8 mol/kg, the total sodium chloride concentration being less than 1.5% by weight, and the pH of the pickled squid being from 6.5 to 8.6.

TABLE 5

| | | |
|---|---|---|
| Formulation | Sodium Chloride | 0.5 |
| (wt %) | Trisodium Citrate | 2.5 |
| | Potassium Chloride | 2 |

| | |
|---|---|
| The aqueous solution ionic strength (mol/kg) | 0.94 |
| The total ionic strength (mol/kg) | 0.47 |
| The pH of the pickled squid | 6.87 |
| The pickling yield (wt %) | 123.9 |
| The texture of the squid | 1.5 |

### Example 9

### Effect of Pickling on Octopus

In order to examine the effect of pickling on octopus, the pickling solution was prepared according to the formulation shown in Table 6. Frozen octopus (Octopus ocellatus) was thawed and cut to from 5 to 10 g, and pickled for 18 hours using a 100% by weight pickling solution with respect to the weight of the octopus. The heat treatment after pickling was boiled for 5 minutes in hot water at 100%, followed by cooling with ice water for 1 minute.

The definition of the measurement items in Table 6 is the same as in Example 1, and the sensory evaluation was performed on the heated sample in the same manner as in Example 2. The texture of the octopus was evaluated as follows in increments of 0.5 (n=3) based on an evaluation standard from 0 to 2 points; “texture having a feel of octopus elasticity (2 points)”, “slightly jelly-like texture (1 point)”, and “overall jelly-like texture (0 point). A score of 1 or lower was judged to be unpleasant because the texture was not octopus-like.

The results are shown in Table 6. Also for octopus, it was found that the yield after pickling was high, and the octopus-like texture was maintained by satisfying the conditions of the total ionic strength being from 0.2 to 0.8 mol/kg, the total sodium chloride concentration being less than 1.5% by weight, and the pH of the pickled octopus being from 6.5 to 8.6.

TABLE 6

| | | |
|---|---|---|
| Formulation | Sodium Chloride | 0.5 |
| (wt %) | Trisodium Citrate | 2.5 |
| | Potassium Chloride | 2 |

| | |
|---|---|
| The aqueous solution ionic strength (mol/kg) | 0.94 |
| The total ionic strength (mol/kg) | 0.47 |
| The pH of the pickled octopus | 6.76 |
| The pickling yield (wt %) | 123.5 |
| The texture of the octopus | 2 |

### Example 10

### Effect of Pickling on Scallops

In order to examine the effect of pickling on scallop, the pickling solution was prepared according to the formulation shown in Table 7. Frozen scallop adductor (Wakkanai scallop adductor) was thawed and pickled for 18 hours using a 100% by weight pickling solution with respect to the weight of the scallop. The heat treatment after pickling was baking for 5 minutes and 30 seconds in an oven at 270° C.

The definition of the measurement items in Table 7 is the same as in Example 1, and the sensory evaluation was performed on the heated sample in the same manner as in Example 2. The texture of the scallop was evaluated as follows in increments of 0.5 (n=3) based on an evaluation standard of 0 to 2 points: “texture having a feel of scallop elasticity (2 points)”, “slightly jelly-like texture (1 point)”, and “overall jelly-like texture(0 point). A score of 1 or lower was judged to be unpleasant because the texture was not scallop-like.

The results are shown in Table 7. Also for scallop, it was found that the yield after pickling was high, and the scallop-like texture was maintained by satisfying the conditions of the total ionic strength being from 0.2 to 0.8 mol/kg, the total sodium chloride concentration being less than 1.5% by weight, and the pH of the pickled scallop being from 6.5 to 8.6.

TABLE 7

| | | |
|---|---|---|
| Formulation | Sodium Chloride | 0.5 |
| (wt %) | Trisodium Citrate | 2.5 |
| | Potassium Chloride | 2 |

| | |
|---|---|
| The aqueous solution ionic strength (mol/kg) | 0.94 |
| The total ionic strength (mol/kg) | 0.47 |
| The pH of the pickled scallops | 6.67 |
| The pickling yield (wt %) | 118.2 |
| The texture of the scallops | 1.5 |

### INDUSTRIAL APPLICABILITY

The pickling method according to an aspect of the present invention suppresses drip during freezing and heating, and thus can provide pickled marine products in which the loss of umami is reduced, and the taste and texture of the marine products are retained.

1. A method for pickling a marine product under conditions satisfying the following a) to c):
a) a total ionic strength during treatment is from 0.2 to 0.8 mol/kg;
b) a total sodium chloride concentration is less than 1.5% by weight; and
c) a pH of the pickled marine product is from 6.5 to 8.6, where the total ionic strength and the total sodium chloride concentration mean an ionic strength and a sodium chloride concentration with respect to a sum of a weight of the marine product and a weight of water of a pickling solution, assuming that the weight of the marine product is the weight of the water.

2. The method according to claim 1, wherein
d) a total trisodium citrate concentration is 1% by weight or greater.

3. The method according to claim 1, wherein the pH of the pickled marine product of c) is from 6.5 to 8.3.

4. The method according to claim 1, wherein a salt used for pickling is an organic acid salt and/or an inorganic acid salt that can be used for food.

5. The method according to claim 4, wherein the salt used for pickling is any one of a sodium salt, a potassium salt, a calcium salt, a magnesium salt, or a combination thereof.

6. The method according to claim 4, wherein the salt used for pickling is any one of a citrate, a carbonate, a bicarbonate, ascorbic acid, an erythorbate, a lactate, a succinate, an acetate, a malate, a fumarate, a gluconate, a polymerized phosphate, a hydrochloride, or a combination thereof.

7. The method according to claim 1, wherein a pickling time is from 1 to 48 hours.

8. The method according to claim 1, wherein the marine product is sprinkled with the salt in powder form, water is added to satisfy conditions a) to c) or a) to d), and then the marine product is pickled therein.

9. The method according to claim 8, wherein the sprinkling with the salt in powder form is followed by retention for 0.5 to 2 hours, addition of water, and pickling for a total of 1 to 48 hours.

10. A pickled marine product satisfying the following a) to c):
a) an ionic strength is from 0.2 to 0.8 mol/kg:
b) a sodium chloride concentration is less than 1.5% by weight; and
c) a pH is from 6.5 to 8.6.

11. The marine product according to claim 10, further satisfying the following d):
d) a trisodium citrate concentration is 1% by weight or greater.

12. The pickled marine product according to claim 10, wherein the pH of c) is from 6.5 to 8.3.

13. The marine product according to claim 10, which is pickled with an organic acid salt and or an inorganic acid salt that can be used for food.

14. The marine product according to claim 13, wherein the organic acid salt and/or inorganic acid salt is any one of a sodium salt, a potassium salt, a calcium salt, a magnesium salt, or a combination thereof.

15. The marine product according to claim 13, wherein the organic acid salt and/or inorganic acid salt is any one of a citrate, a carbonate, a bicarbonate, an ascorbic acid, an erythorbate. lactate, a succinate, an acetate, a malate, a fumarate, a gluconate, a polymerized phosphate, a hydrochloride, or a combination thereof.

16. A pickling solution with a marine product pickled therein, satisfying the following a) to c):
a) a total ionic strength is from 0.2 to 0.8 mol/kg;
b) a total sodium chloride concentration is less than 1.5% by weight; and
c) a pH is from 7.0 to 9.5.

17. The pickling solution with a marine product pickled therein according to claim 16, further satisfying the following d):
d) a total trisodium citrate concentration is 1% by weight or greater.

18. The pickling solution with a marine product pickled therein according to claim 16, wherein the salt used is an organic acid salt and/or an inorganic acid salt that can be used for food.

19. The pickling solution with a marine product pickled therein according to claim 18, wherein the organic acid salt and/or inorganic acid salt is any one of a sodium salt, a potassium salt, a calcium salt, a magnesium salt, or a combination thereof.

20. The pickling solution with a marine product pickled therein according to claim 18, w herein the organic acid salt and/or an inorganic acid salt is any one of a citrate, a carbonate, a bicarbonate, ascorbic acid, an erythorbate, a lactate, a succinate, an acetate, a malate, a fumarate, a gluconate, a polymerized phosphate, a hydrochloride, or a combination thereof.
